(19) United States
(12) Patent Application Publication
(10) Pub. No.: US 2018/0060388 A1
(43) Pub. Date: Mar. 1, 2018

(54) PRE-APPLYING A REDUCED VERSION OF A SEARCH QUERY TO LIMIT THE SEARCH SCOPE

(71) Applicant: Quest Software Inc., Aliso Viejo, CA (US)

(72) Inventors: Artem Nikolaevich Goussev, St. Petersburg (RU); Vadim Alexandrovich Senchukov, St. Petersburg (RU)

(21) Appl. No.: 15/248,275

(22) Filed: Aug. 26, 2016

(51) Int. Cl. G06F 17/30

(52) U.S. Cl. CPC G06F 17/30451; G06F 17/30457

(57) ABSTRACT

A reduced version of a search query can be pre-applied to limit the search scope. A query processor can maintain one or more metadata structures for a structured data store where each metadata structure is based on a single field of documents that are stored in the structured data store. When a search query is received, the query processor can generate a reduced version of the search query to be run against one of the metadata structures. The results of running the reduced version of the search query will identify which of the portions of the structured data store the full search query should be run against. In this way, the query processor can avoid loading and evaluating the search query against all portions of the structured data store.

### CROSS-REFERENCE TO RELATED APPLICATIONS

N/A

### BACKGROUND

The present invention is generally directed to optimizing the execution of a search query. In particular, the present invention can be employed to pre-apply a reduced version of a search query to limit the search scope.

In some computing environments, a server provides access to an indexed store which can be searched. In such environments, clients may submit requests to the server for searching the indexed store for specified content. In response, the server will perform the necessary operations to load segments of the indexed store and then search within the loaded segments for the specified content. Under ideal conditions, the server will be capable of executing these searches in an acceptable amount of time. However, in many cases, the server may receive too many searches which may overload the server and cause its performance to suffer. For example, each time a search is executed, the server will be required to load each segment of the indexed store resulting in a large number of disk operations and a large amount of memory consumption. Further, if the indexed store happens to be stored in network storage, these loads will occur over the network which may result in the network becoming congested. When this overloading occurs, a search may be executed in an unacceptably slow manner or may even fail.

To address these overload scenarios, many systems may limit the number of concurrent requests. In such cases, if a client submits a request when the server is overloaded, the server may deny the request. Such denials extend the performance shortcomings to the client. Further, the denials can give the perception that the system is faulty or otherwise unsatisfactory.

### BRIEF SUMMARY

The present invention extends to methods, systems, and computer program products for pre-applying a reduced version of a search query to limit the search scope. A query processor can maintain one or more metadata structures for a structured data store where each metadata structure is based on a subset of the fields of documents that are stored in the structured data store. When a search query is received, the query processor can generate a reduced version of the search query to be run against one of the metadata structures. The results of running the reduced version of the search query will identify which of the portions of the structured data store the full search query should be run against. In this way, the query processor can avoid loading and evaluating the search query against all portions of the structured data store.

In one embodiment, the present invention is implemented as a method in a server system that includes a query processor for running search queries against a structured data store containing a plurality of portions that store documents having a plurality of fields including a first field. The method can be performed by the query processor to identify a subset of the portions against which a search query should be run. The query processor can maintain a first metadata structure that includes a metadata portion for each portion in the structured data store. Each metadata portion identifies values of the first field that exist in the corresponding portion. The query processor can receive a first search query that includes the first field as a parameter as well as one or more other fields of the plurality of fields as parameters. The query processor can generate a reduced version of the first search query that does not include the one or more other fields. The query processor can then run the reduced version of the first search query against the metadata portions of the first metadata structure to identify which metadata portions match the reduced version of the first search query. The query processor may then run the first search query against a subset of the portions of the structured data store where the subset includes only portions of the structured data store that correspond to a metadata portion identified by running the reduced version of the first search query.

In another embodiment, the present invention is implemented as computer storage media storing computer executable instructions which, when executed on a server system that includes a query processor for running search queries against a structured data store containing a plurality of portions that store documents having a plurality of fields including a first field, perform a method for identifying a subset of the portions against which a search query should be run. This method can include the following steps: maintaining a first metadata structure that includes a metadata portion for each portion of the structured data store, each metadata portion storing metadocuments corresponding to documents in the corresponding portion, each metadocument including only the first field; receiving a first search query that includes the first field as a parameter as well as one or more other fields of the plurality of fields as parameters; generating a reduced version of the first search query that does not include the one or more other fields; running the reduced version of the first search query against the metadata portions of the first metadata structure to identify which metadata portions match the reduced version of the first search query; and running the first search query against a subset of the portions of the structured data store, the subset including only portions of the structured data store that correspond to a metadata portion identified by running the reduced version of the first search query.

In another embodiment, the present invention can be implemented as a server system that includes: an indexed store containing a plurality of segments that store documents having a plurality of fields including a first field; a first metadata structure that includes a metadata segment for each segment in the indexed store, each metadata segment identifying values of the first field that exist in the corresponding segment; and a query processor for running search queries against the indexed store. The query processor is configured to identify a subset of the segments of the indexed store against which the search queries should be run. In response to receiving a search query that includes the first field as a parameter as well as one or more other fields of the plurality of fields as parameters, the query processor can generate a reduced version of the search query that does not include the one or more other fields. The query processor can then run the reduced version of the search query against the metadata segments of the first metadata structure to identify which metadata segments match the reduced version of the search query.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates an example computing environment in which the present invention can be implemented;

FIG. 2 illustrates how a server can receive client requests to search an indexed store on network storage;

FIG. 3 illustrates an example of an indexed store that includes five indexes that each include a single segment;

FIG. 4 illustrates an example metadata structure that can be generated based on a time field of documents stored in the indexed store of FIG. 3;

FIG. 4A illustrates another example metadata structure that can be generated based on the time field;

FIG. 4B illustrates another example metadata structure that can be generated based on the time field and a FIELD1 field;

FIG. 5 illustrates how the query processor can generate a reduced version of a search query for targeting the metadata structure of FIG. 4;

FIG. 5A illustrates how the query processor can generate a reduced version of a search query for targeting the metadata structure of FIG. 4B;

FIG. 6 illustrates how the reduced version of the search query can be run against the metadata structure to identify which segments of the indexed store the full search query should be run against;

FIG. 7 illustrates another example of how the query processor can generate a reduced version of a search query;

FIGS. 7A and 7B graphically represent how a search query can be transformed into a reduced version; and

FIG. 8 illustrates a flowchart of an example method for identifying a subset of portions of a structured data store against which a search query should be run.

### DETAILED DESCRIPTION

In this specification, the term “structured data store” should be construed as encompassing the various ways in which structured data can be stored including, but not limited to, an indexed store (as that term is defined below), a table-based store (or database), and a file-based store. Therefore, although the invention will primarily be described with reference to an indexed store, it should not be limited to such embodiments and can equally be implemented in conjunction with a table-based store, a file-based store, or another suitable structured data store.

In this specification, the term “index” should be construed as a data structure that stores any type of data in a manner that allows the data to be searched as text. The term “segment” should be construed generally as a portion of an index, i.e., a sub-index. As an example, an index can be created and accessed via the Apache Lucene search engine library. In such cases, an index consists of a sequence of documents where each document consists of a number of terms (i.e., field:value pairs), and the index may be structured as an inverted index, i.e., the index may identify which documents each term appears in. In such cases, the loading of a segment can consist of reading one or more files (e.g., a .cfs file) of the segment into memory.

The term “indexed store” should be construed as a plurality of indexes that are employed to store related data. As an example, in some embodiments, a plurality of Lucene indexes (i.e., an indexed store) may be used to store a particular type or types of data. Also, in such embodiments, each of these indexes could be structured to include a single segment such that the process of searching an index is substantially synonymous with loading a single segment. In other words, as will become more apparent below, a system configured in accordance with embodiments of the present invention may create an indexed store by defining a number of different Lucene indexes and attempting to configure each index so that it includes only a single segment (e.g., by passing in .cfs files that define a single-segment-per-index structure). However, even in such cases, the Lucene engine may create more than one segment in some of these indexes and therefore the invention should not be limited to cases where all indexes include only a single segment.

The term “filed-based store” should be construed as a structured data store where multiple instances of a file are used to store related data. The term “table-based store” should be construed as a structured data store where multiple instances of a table are used to store related data. A structured data store will therefore be comprised of multiple “portions” where these portions may be segments, files, or tables.

The term “document” will be used to generally define a unit of data that is stored in a structured data store. Therefore, in some embodiments such as table-based store embodiments, the term “document” can be used synonymously with the term “record.”

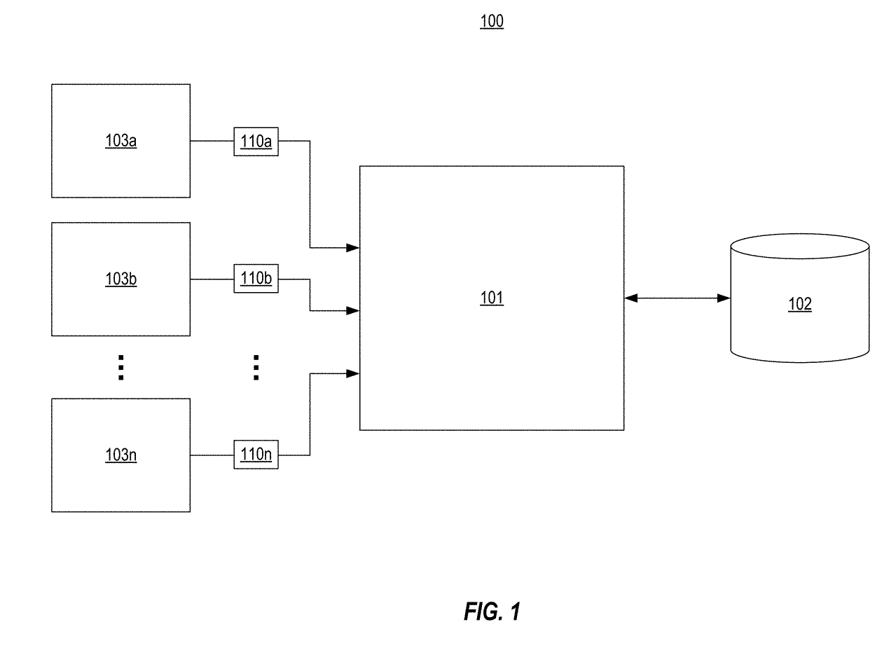

FIG. 1 illustrates an example computing environment 100 in which the present invention can be implemented. Computing environment 100 includes a server 101 that includes or that can otherwise access storage 102. In FIG. 1, storage 102 is depicted as being separate from server 101 to represent embodiments where storage 102 functions as network storage. In other words, server 101 and storage 102 are coupled to a network over which server 101 accesses storage 102. However, the present invention extends to embodiments where storage 102 may be one or more local storage devices (e.g., a local hard drive). Storage 102 is intended to generally represent many different types and/or numbers of storage devices. Accordingly, the particular configuration of storage 102 is not essential to the present invention.

Server 101 can provide an API by which clients 103a-103n can submit requests to access content stored on storage 102. For example, server 101 may implement a REST API by which clients 103a-103n can submit HTTP requests defining queries for accessing a structured data store maintained on storage 102. As represented in FIG. 1, a potentially large number of clients 103a-103n may submit requests 110a-110n at any particular time. As indicated in the background, if too many requests are submitted within a short period of time, server 101 may experience substantial load that could potentially affect its performance. For example, if many of these requests are search requests that require that server 101 load and examine each segment of an indexed store, server 101 could potentially be unable to service each request in a timely manner.

To address such issues and in accordance with embodiments of the present invention, server 101 can implement a technique for pre-applying a reduced version of a search query to limit the search scope. By limiting the search scope of a particular search query, the query can be processed more quickly and with reduced load on server 101 thereby freeing server 101 to handle a greater number of search queries or to perform other processing.

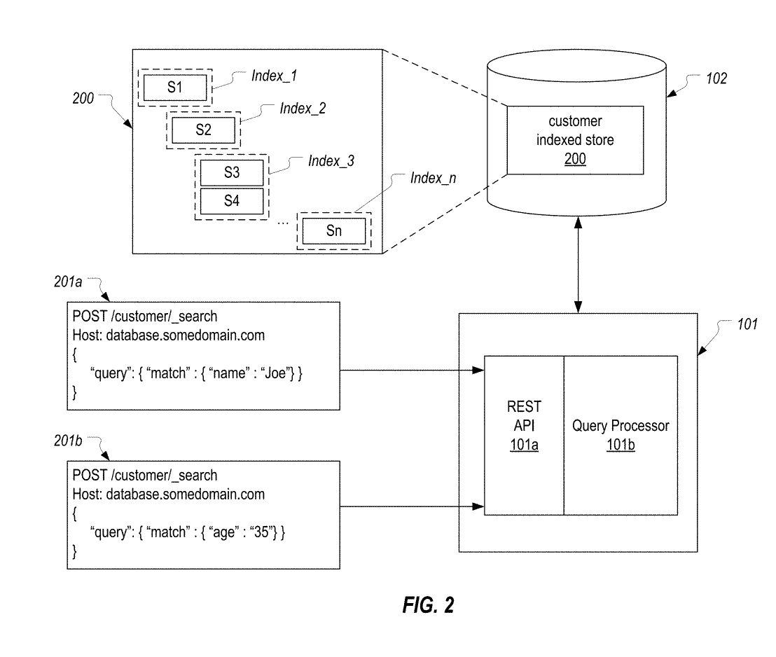

FIG. 2 provides a more detailed example of a computing environment in which the present invention may be implemented. In this example, it is assumed that storage 102 stores a customer indexed store 200 and that server 101 provides a REST API 101a through which clients can submit requests for accessing customer indexed store 200. It is again noted that customer indexed store 200 is an example of only one type of structured data store with which the present invention can be implemented. As shown, customer indexed store 200 can be comprised of a number of indexes (Index_1 through Index_n) each of which preferably includes a single segment. However, even when attempting to confine an index to a single segment, the indexing engine (e.g., the Lucene engine) may sometimes create more than one segments. For this reason, index_3 is shown as including two segments, S3 and S4. In this example, it can be assumed that each of segments 51 through Sn stores customer data.

Server 101 is also shown as including a query processor 101b which is configured to execute queries received via REST API 101a including to issue appropriate commands for loading segments of customer indexed store 200 into memory of server 101 and to evaluate such segments in accordance with the parameters of an executed query. In an example embodiment, query processor 101b may be configured to employ the Lucene code library and API for processing such queries. It is noted, however, that Lucene is only one example of a suitable engine that could be used in embodiments of the present invention.

FIG. 2 also provides two examples of queries 201a, 201b that can be submitted via REST API 101a. Both of queries 201a and 201b comprise search requests of customer indexed store 200 (as indicated by the _search parameter in each request). In particular, first query 201a defines a request to search customer indexed store 200 for documents having a name field with a value of Joe, whereas second query 201b defines a request to search customer indexed store 200 for documents having an age field with a value of 35. It is noted that queries 201a and 201b are generally formatted in accordance with the Elasticsearch API which is one example of a REST API that can be employed to provide access to customer indexed store 200. However, the present invention should not be limited to Elasticsearch or any other provider, but should extend to any implementation that allows clients to search an index or indexed store including those that provide an API other than a REST API for such access.

Because queries 201a and 201b are both directed to customer indexed store 200 and both involve searching for documents matching particular parameters, it will be necessary to load each segment of customer indexed store 200 and evaluate each document in customer indexed store 200 against the parameters. In a Lucene-based example, this loading of the segments of customer indexed store 200 can be accomplished by calling the open method of the IndexReader class to open a directory containing one of the indexes of customer indexed store 200. As an example and assuming each directory has the same name as the index it contains, query processor 101b may call “IndexReader indexReader=IndexReader.open(Index_1)” to load each segment of Index_1 (which in this case is only segment S1) and may then create a searcher for searching the loaded index, e.g., by calling “IndexSearcher indexSearcher=new IndexSearcher(indexReader).” A query can then be executed against the segment(s) as is known in the art.

As introduced in the background, this process of loading a segment (i.e., the process of opening a directory containing an index comprised of one or more segments) requires a relatively large amount of overhead and can overwhelm a system when a large number of queries are processed within a short period of time. For example, if four search queries are being executed at the same time, each query may cause a different segment to be loaded into memory thereby quickly exhausting memory or possibly preempting another active segment. Similar issues may exist when the structured data store is formatted as a table-based store or a file-based store. For example, the four queries may require the loading of different tables of a table-based store or different files of a file-based store.

To address this issue or to otherwise increase the efficiency of processing a search query, the present invention can provide a way to limit the scope of a search query so that the search query does not need to be run against all segments in the indexed store, all tables in a table-based store, all files in a file-based store, etc. In particular, the present invention can employ a specialized metadata structure against which a reduced version of a search query can be run to identify which portions of the structured data store will return results of the search query. The search query can then be run only against the identified portions thereby minimizing the amount of processing (e.g., segment loads) that must be performed to evaluate the search query.

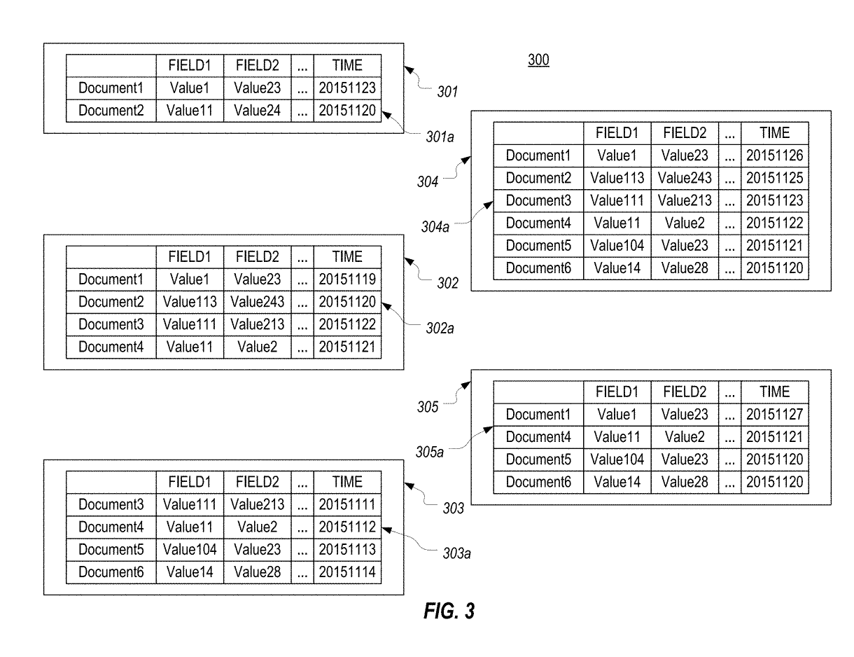

FIG. 3 provides a simplified and generalized example of an indexed store 300 that includes five indexes 301-305, each of which includes a single segment 301a-305a respectively. However, as noted above, any one of indexes 301-305 may have multiple indexes. It will be assumed that each of indexes 301-305 is used to store documents having a structure of:

```
Document {
  FIELD1
  FIELD2
  FIELD3
  FIELD4
  FIELD5
  TIME
}
```

where the FIELD1 through FIELD5 fields can represent any possible field for storing any possible value or values and the TIME field is used to store one or more timestamps. For simplicity, this example will assume that each field only stores a single value. Of course, the present invention can be implemented when an indexed store stores documents having any number and type of fields. As those of skill in the art understand, a table-based store or file-based store could be used to store the same information (e.g., by using a table structure having a column for each of the fields).

In a typical scenario, if a search query for documents matching a particular set of parameters is received, query processor 101b would be required to run the query against each of segments 301a-305a to identify any matching documents. This can include comparing the parameters of the search query to the values in multiple fields. In cases where the documents include a relatively large number of fields that must be compared and/or if the number and/or size of segments/indexes in indexed store 300 is large, the processing required to run the query could be substantial. Therefore, the present invention can provide a way to efficiently determine which segments the query does not need to be run against.

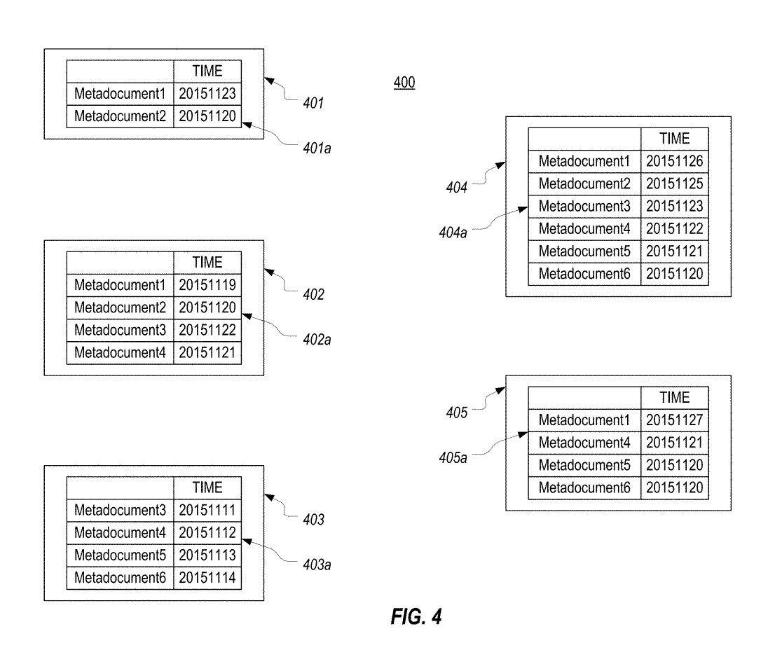

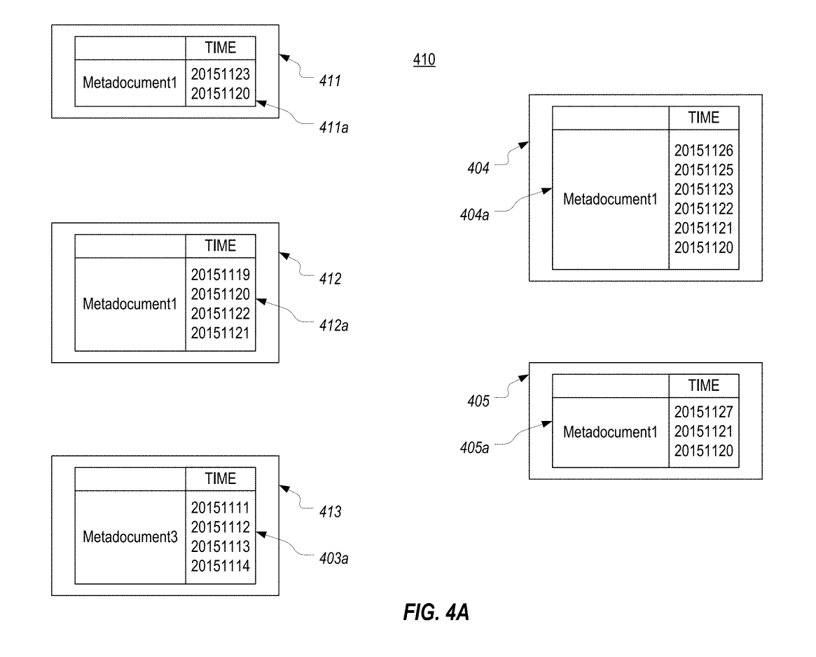

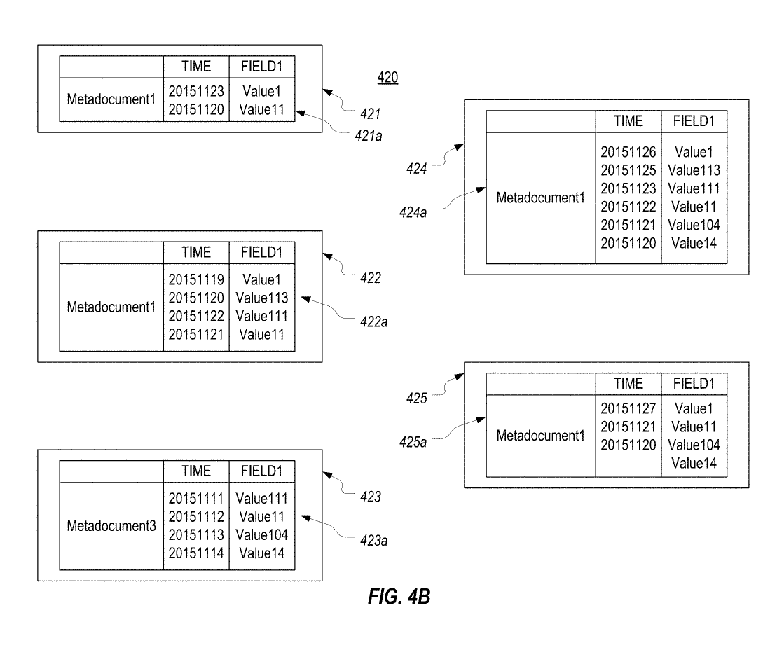

FIG. 4 illustrates an example of how the present invention can create a metadata structure (or metadata indexed store) 400 consisting of a metadata segment (or “metadata portion”) for each segment in indexed store 300. Accordingly, metadata structure 400 includes metadata indexes 401-405 which include metadata segments 401a-405a respectively. In some embodiments, such as is depicted in FIG. 4, metadata segments 401a-405a can each store “metadocuments” that correspond to the documents in the corresponding segment of indexed store 300 but that only include a single field. In other words, a metadocument is a document from an indexed store that has been reduced to a single field. In this example, this field is the TIME field. In other embodiments, a metadocument may include more than one field (e.g., two fields or three fields) as long as the number of fields in the metadocument is less than the number of fields in the corresponding documents. For example, a metadocument could include the TIME field and FIELD1.

Also, in some embodiments, a metadata segment (or metadata portion) may not include a metadocument for each document, but may instead include a metadocument that corresponds to more than one document. FIG. 4A provides an example of such embodiments. As shown, a metadata structure 410 includes metadata indexes 411-415 which store metadata segment 411a-415a. Unlike metadata segments 401a-405a, metadata segments 411a-415a store one or more metadocuments that have multiple values. Either of the formats shown in FIGS. 4 and 4A could equally be employed as long as each metadata segment stores all of the values for the field or fields that appear in the corresponding segment. In other words, the metadata portion should store all values of a field that appear in the corresponding portion. For example, both metadata segment 401a and metadata segment 411a store the same timestamps (20151126 and 20151120) which represent the timestamps that appear in segment 301a.

FIG. 4B provides an example of a metadata structure 420 that includes metadata indexes 421-425 which store metadata segments 421a-425a. Unlike metadata structures 400 and 410 which only include the TIME field, metadata structure 420 represents a case where indexed store 300 has been reduced to the TIME and FIELD1 fields.

In cases where a metadata structure may be created for a file-based store or a table-based store, the metadata structure will consist of a metadata file or metadata table for each file or table in the file-based store or table-based store respectively. Accordingly, the term “metadata portion” will be used to generally refer to these components (metadata segments, metadata tables, or metadata files) of a metadata structure which correspond to the portions (segments, tables, or files) of the structured data store.

As suggested above, multiple metadata structures could be created for a structured data store (such as indexed store 300) for reasons that will be described below. For example, in addition to metadata structure 400, another metadata structure that includes metadocuments with only FIELD1 or only FIELD5 could be created. Likewise, a metadata structure that includes metadocuments with both FIELD2 and the TIME field could be created. These metadata structures can be created by query processor 101b by running appropriate queries against indexed store 300 to retrieve the value of the appropriate field or fields. For example, in the case of metadata structure 400, a query that retrieves the timestamp of each document can be run against each of segments 301a-305a. Using the results of such queries, query processor 101b can then create metadata structure 400. After metadata structure 400 has been created, query processor 101b can update it as necessary (e.g., when documents are added to or deleted from a segment in indexed store 300).

Once one or more metadata structures have been created for an indexed store, query processor 101b can employ a metadata structure to identify a subset of segments in the indexed store against which a particular query will need to be run. Although creating a metadata structure may require substantial processing, its subsequent use to limit the scope of many queries can provide a significant reduction in processing over time.

In addition to creating and maintaining metadata structure 400, query processor 101b can also be configured to generate a reduced version of a search query which can then be run against metadata segments 401a-405a the results of which will identify against which segments in indexed store 300 the full query should be run. In other words, when a search query is received, query processor 101b can: (1) generate a reduced version of the search query; (2) run the reduced version of the search query against metadata structure 400 (and/or against one or more other metadata structures that have been created for indexed store 300) to identify which metadata segments return result(s); and (3) run the full search query only against segments in indexed store 300 corresponding to the metadata segments that returned result(s).

Because the metadocuments in the metadata segments include only a single field (or at least a reduced set of fields), the execution of the reduced version of the search query can be completed quickly (i.e., with far less processing than would be required if the full search query is run against all segments in indexed store 300). In most cases, the execution of the reduced version of the search query will identify a subset of the segments in indexed store 300 which in turn will free query processor 101b from needing to run the full search query against a number of segments.

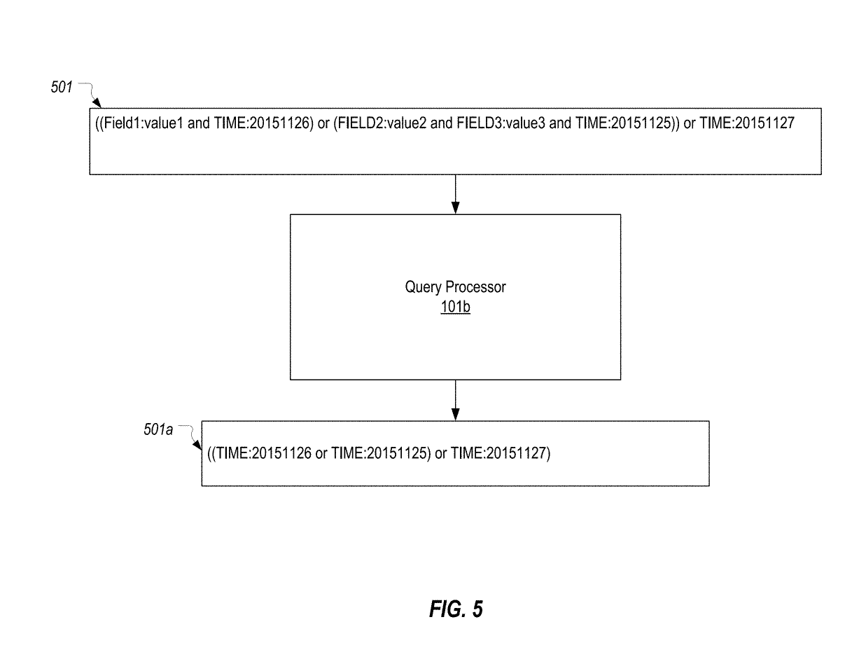

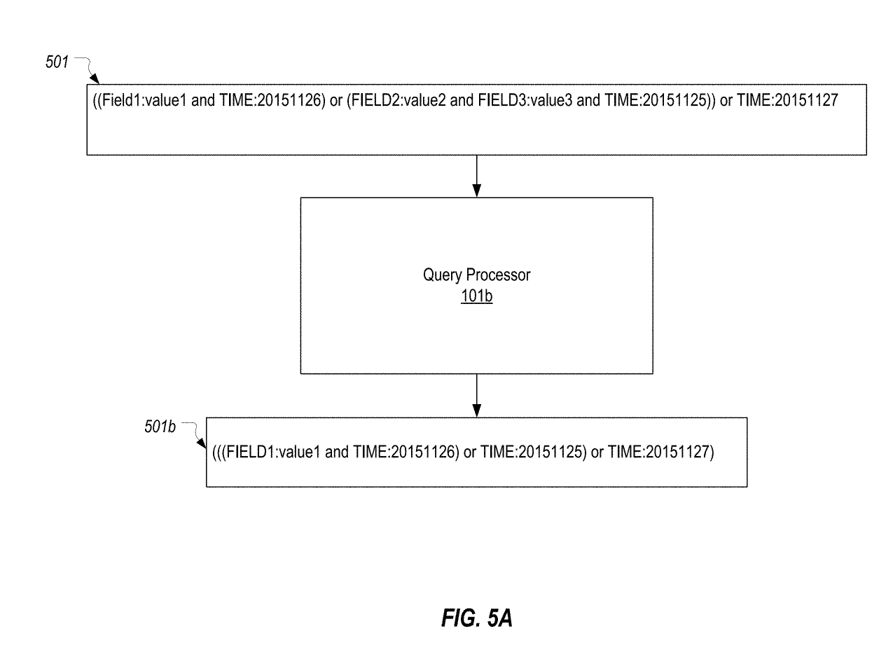

FIG. 5 illustrates a simple example of how query processor 101b can generate a reduced version of a search query. As shown, query processor 101b can receive a search query 501 that includes a number of field/value pairs and targets indexed store 300. Query processor 101b can analyze search query 501 in view of any metadata structures that have been created for indexed store 300. In this case, it is assumed that only metadata structure 400 has been created. Therefore, query processor 101b can analyze whether search query 501 includes the TIME field. In this case, query processor 101b will determine that search query 101b includes multiple instances of the TIME field and can therefore be converted into a reduced version 501a that only includes TIME fields.

This conversion of search query 501 into reduced version 501a can be accomplished by converting search query 501 into a logical tree and then reducing the logical tree into a simpler tree that keeps the values for TIME fields but substitutes a neutral value (e.g., undefined) for all other fields. With the neutral values substituted, the tree can be minimized in accordance with the following four rules:
undefined AND x=x
x AND undefined=x
undefined OR x=undefined
x OR undefined=undefined
   where x represents the value of the field on which the metadata structure is based. Therefore, in this case, x can represent the timestamps.

In this case, “FIELD1:value1 and TIME:20151126” can be reduced to TIME:20151126, while “FIELD2:value2 and FIELD3:value3 and TIME:20151125” can be reduced to TIME:20151125. As a result, a reduced version 501a of query 501 is produced as “((TIME:20151126 or TIME:20151125) or TIME:20151127)”

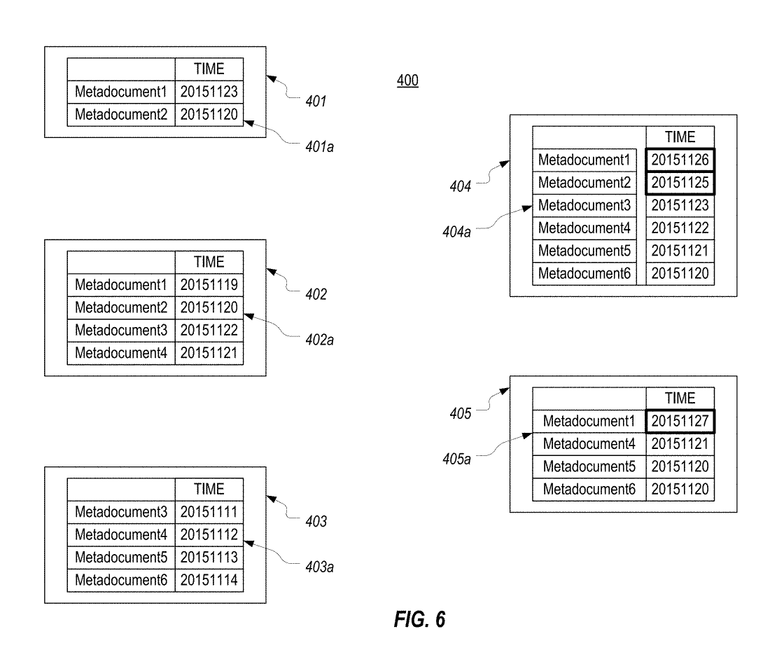

Reduced version 501a of search query 501 therefore represents a query that can be applied to metadata structure 400 to return metadata segments that include metadocuments matching the timestamp values in search query 501. In essence, running reduced version 501a against metadata structure 400 functions as a filter for removing any segment in indexed store 300 that will not yield results to search query 501. For example, FIG. 6 illustrates that only metadata segments 404a and 405a include documents matching the parameters of reduced version 501a. In particular, metadata segment 404a includes metadocuments having timestamps of 20151126 and 20151125, while metadata segment 405a includes a metadocument having a timestamp of 20151127.

Because metadata segments 401a, 402a, and 403a do not include metadocuments matching the parameters of reduced version 501a, query processor 101b can know that search query 501 would not yield results if run against segments 401, 402, or 403. The same result could be reached by running reduced version 501a against metadata structure 410. Therefore, query processor 101b can cause search query 501 to only be run against segments 404 and 405. In this way, the amount of processing required to execute search query 501 is reduced. More particularly, the amount of processing required to execute reduced version 501a is substantially less than the amount of processing required to run search query 501 against segments 401, 402, and 403. Therefore, the techniques of the present invention will significantly reduce the overall processing required to execute many, if not most, search queries.

FIG. 5A provides an example of how query processor 101b could generate a reduced version 501b of query 501 that targets metadata structure 420. Because metadata structure 420 includes both the TIME and FIELD1 fields, query processor 101b can apply the rules above to reduce query 501 to only the TIME and FIELD1 fields. Reduced version 501b could then be run against metadata structure 420 which would yield results from metadata segments 424a and 425a thereby indicating that query 501 should only be run against segments 404 and 405. It is noted that, in these examples, the results of running reduced versions 501a and 501b happen to be the same. However, this need not be the case as will be further described below.

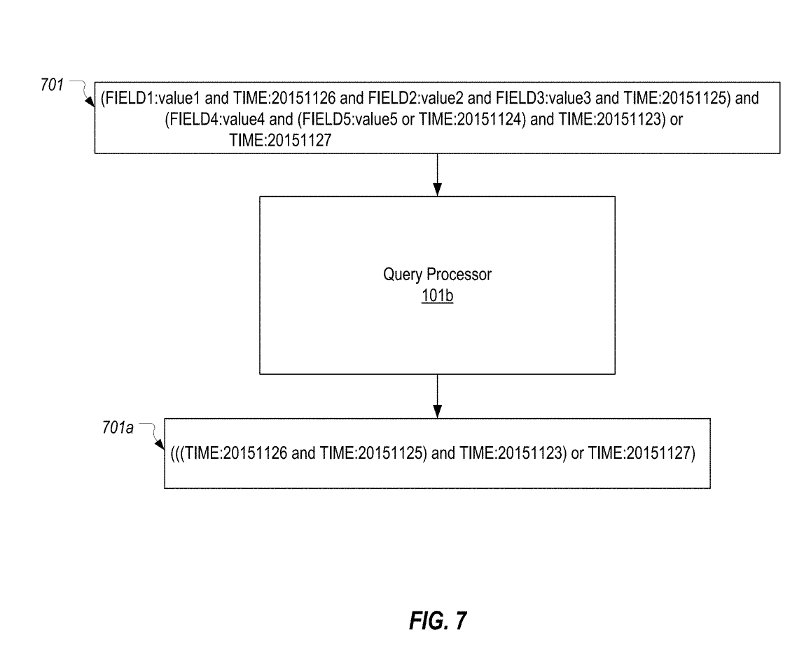

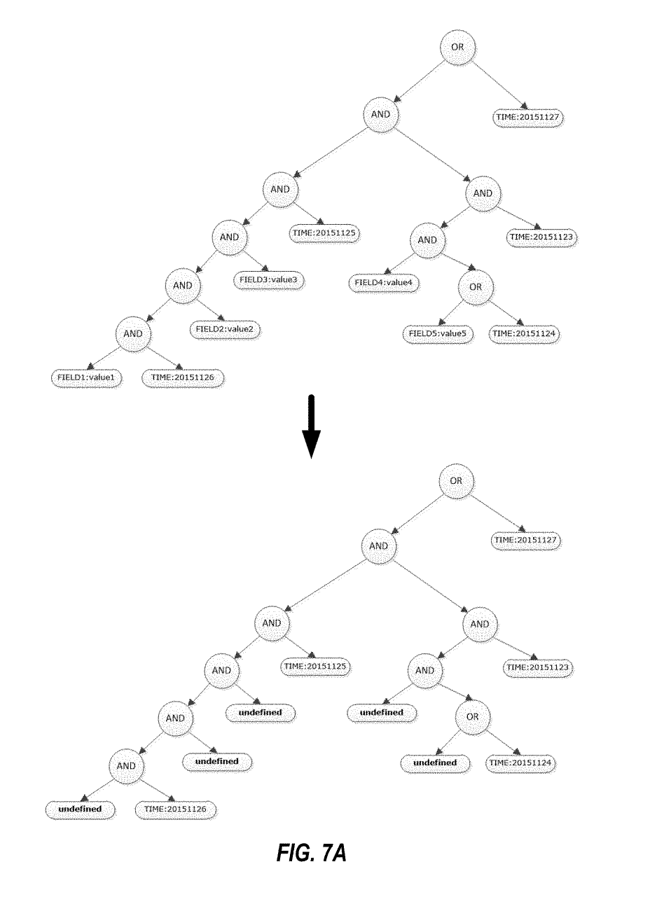

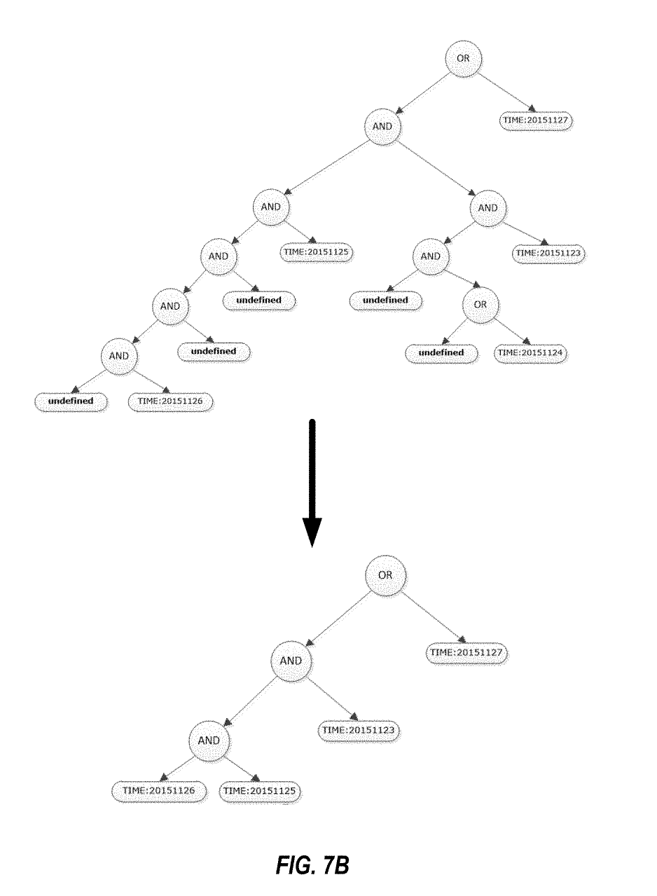

As indicated above, query 501 is a very simple query. To better illustrate how query processor 101b generates a reduced version of a query for targeting a metadata structure, FIG. 7 is provided. In FIG. 7, a query 701 is shown as being converted into a reduced version 701a. For purposes of this example, it will be assumed that query 701 targets an indexed store similar to indexed store 300 except that the TIME field can store multiple values and that an appropriate metadata structure has been generated that is limited to the TIME field.

Accordingly, to produce reduced version 701a, “FIELD1:value1 and TIME:20151126” can be reduced to TIME:20151126, then “TIME:20151126 and FIELD2:value2” can be further reduced to TIME:20151126, then “TIME:20151126 and FIELD3:value3” can be further reduced to TIME:20151126 yielding (TIME:20151126 and TIME:20151125) from the first portion of search query 501. Similar reductions can be performed on the remainder of search query 701 to yield reduced version 701a of (((TIME:20151126 and TIME:20151125) and TIME:20151123) or TIME:20151127) as shown. FIGS. 7A and 7B graphically represent how the logical tree representing search query 701 can be converted into a simplified tree defining reduced version 701a.

With reduced version 701a generated, query processor 101b can execute reduced version 701a against the metadata structure to identify which segments of the indexed store will yield results to query 701. In particular, the execution of reduced version 701a will identify which segments of the indexed store have at least one document that either: (1) includes a TIME field with values 20151126, 20151125, and 20151127; or (2) includes a TIME field with a value of 20151127.

As indicated above, a number of different metadata structures may be created for an indexed store where each metadata structure can be based on a different field or combination of fields of the documents stored in the indexed store. In cases where multiple metadata structures exist, query processor 101b can determine which metadata structure to employ for a particular search query. For example, if a search query targeting indexed store 300 did not include the TIME field, query processor 101b would not generate a reduced version of the search query for metadata structure 400 but could instead generate a reduced version of the search query targeting another metadata structure that may have been created for indexed store 300 and that may be more suitable for the specific parameters of the search query (e.g., a reduced version of the search query based on FIELD1 when the search query includes at least one instance of FIELD1 as a parameter). As another example, if a metadata structure is created for the combination of FIELD1 and the TIME field, query processor 101b may reduce a search query to target this metadata structure. In this case and with reference to query 701, a reduced version of query 701 could be created as (((FIELD1:value1 and TIME:20151126 and TIME:20151125) and TIME:20151123) or TIME:20151127). In other words, when generating a reduced version of a query to target a particular metadata structure, query processor 101b can retain the fields that are represented in the particular metadata structure while reducing the query in accordance with the rules defined above.

Also, in some embodiments, query processor 101b may generate more than one reduced version of a search query where each reduced version targets a different metadata structure. In such cases, query processor 101b could employ the intersection of the results of running each reduced version of the search query to identify which segments the full search query should be run against. For example, if a metadata structure based on FIELD1 had also been created for indexed store 300 and a reduced version of search query 501 run against this metadata structure only identified a metadata structure corresponding to segment 404, query processor 101b would know that search query 501 should only be run against segment 404a.

This same process of generating one or more metadata structures and then generating reduced versions of queries to target the metadata structures can be performed regardless of which type of structured data store is involved. For example, if indexed store 300 were instead configured as a table-based store (e.g., by using multiple instances of a table as opposed to multiple indexes/segments), a metadata structure consisting of a “metadata table” for each table in the table-based store could be created. Similarly, if indexed store 300 were instead configured as a file-based store (e.g., by using multiple instances of a file as opposed to multiple indexes/segments), a metadata structure consisting of a “metadata file” for each file in the file-based store could be created. In either of these cases, the generation of a reduced version of a query could be carried out in substantially the same manner as described above in order to minimize the number of tables/files against which the full query will need to be run.

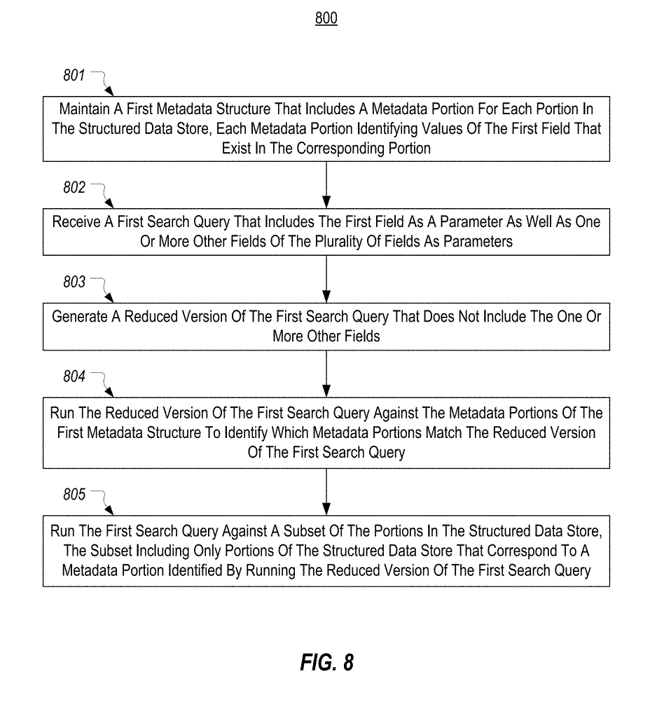

FIG. 8 provides a flowchart of an example method 800 for identifying a subset of the portions of a structured data store against which a search query should be run. Method 700 can be performed by query processor 101b and will be described with reference to FIGS. 3-6.

Method 800 includes an act 801 of maintaining a first metadata structure that includes a metadata portion for each portion in the structured data store, each metadata portion identifying values of the first field that exist in the corresponding portion. For example, query processor 101b can maintain metadata structure 400 or 410.

Method 800 includes an act 802 of receiving a first search query that includes the first field as a parameter as well as one or more other fields of the plurality of fields as parameters. For example, query processor 101b can receive search query 501.

Method 800 includes an act 803 of generating a reduced version of the first search query that does not include the one or more other fields. For example, query processor 101b can generate reduced version 501a of search query 501.

Method 800 includes an act 804 of running the reduced version of the first search query against the metadata portions of the first metadata structure to identify which metadata portions match the reduced version of the first search query. For example, query processor 101b can run reduced version 501a against metadata structure 400 to identify that only metadata segments 404a and 405a match reduced version 501a.

Method 800 includes an act 805 of running the first search query against a subset of the portions in the structured data store, the subset including only portions of the structured data store that correspond to a metadata portion identified by running the reduced version of the first search query. For example, query processor 101b can run search query 501 only against segment 304a and 305a (or against indexes 304 and 305).

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer- executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. In a server system that includes a query processor for running search queries against a structured data store containing a plurality of portions that store documents having a plurality of fields including a first field, a method, performed by the query processor, for identifying a subset of the portions against which a search query should be run, the method comprising:
maintaining a first metadata structure that includes a metadata portion for each portion in the structured data store, each metadata portion identifying values of the first field that exist in the corresponding portion;
receiving a first search query that includes the first field as a parameter as well as one or more other fields of the plurality of fields as parameters;
generating a reduced version of the first search query that does not include the one or more other fields;
running the reduced version of the first search query against the metadata portions of the first metadata structure to identify which metadata portions match the reduced version of the first search query; and
running the first search query against a subset of the portions in the structured data store, the subset including only portions of the structured data store that correspond to a metadata portion identified by running the reduced version of the first search query.

2. The method of claim 1, wherein each metadata portion stores metadocuments having the first field, each metadocument storing a value of the first field that is the same as a value of the first field in one or more documents in the corresponding portion of the structured data store.

3. The method of claim 1, wherein each metadata portion also identifies values of one or more additional fields of the plurality of fields, the first search query also includes the one or more additional fields, and the reduced version of the first search query includes the one or more additional fields.

4. The method of claim 1, wherein the first search query includes multiple instances of the first field.

5. The method of claim 4, wherein the multiple instances of the first field are combined with Boolean logic.

6. The method of claim 1, wherein generating a reduced version of the first search query that does not include the one or more other fields comprises substituting a value of each of the one or more other fields with a neutral value.

7. The method of claim 1, wherein generating a reduced version of the first search query that does not include the one or more other fields comprises:
converting the first search query into a logical tree;
substituting a neutral value for a value of each of the one or more other fields;
reducing the logical tree by removing from the logical tree any occurrence where a neutral value is combined with a value of the first field using a logical OR; and
converting the reduced logical tree into the reduced version of the first search query.

8. The method of claim 1, wherein the plurality of fields includes a second field, the method further comprising:
maintaining a second metadata structure that includes a metadata portion for each portion in the structured data store, each metadata portion in the second metadata structure identifying values of the second field that exist in the corresponding segment;
receiving a second search query that includes the second field as a parameter as well as one or more other fields of the plurality of fields as parameters;
generating a reduced version of the second search query that does not include the one or more other fields included in the second search query;
running the reduced version of the second search query against the metadata portions of the second metadata structure to identify which metadata portions match the reduced version of the second search query; and
running the second search query against a subset of the portions in the structured data store, the subset including only portions of the structured data store that correspond to a metadata portion identified by running the reduced version of the second search query.

9. The method of claim 1, wherein the plurality of fields includes a second field and the first search query includes the second field as a parameter, the method further comprising:
maintaining a second metadata structure that includes a metadata portion for each portion in the structured data store, each metadata portion in the second metadata structure identifying values of the second field that exist in the corresponding portion;
generating a second reduced version of the first search query that does not include the first field or the one or more other fields; and
running the second reduced version of the first search query against the metadata portions of the second metadata structure to identify which metadata portions match the second reduced version of the first search query;
wherein the subset of portions against which the first search query is run includes only portions of the structured data store that correspond to a metadata portion that was identified by both the reduced version of the first search query and the second reduced version of the first search query.

10. The method of claim 1, further comprising:
updating the metadata structure in response to an update to the structured data store.

11. The method of claim 10, wherein updating the metadata structure comprises adding a metadocument to or removing a metadocument from a metadata portion in response to a corresponding document being added to or removed from a corresponding portion.

12. The method of claim 10, wherein updating the metadata structure comprises adding a metadata portion in response to a portion being added to the structured data store.

13. One or more computer storage media storing computer executable instructions which, when executed on a server system that includes a query processor for running search queries against a structured data store containing a plurality of portions that store documents having a plurality of fields including a first field, perform a method for identifying a subset of the portions against which a search query should be run, the method comprising:
maintaining a first metadata structure that includes a metadata portion for each portion in the structured data store, each metadata portion storing metadocuments corresponding to documents in the corresponding portion, each metadocument including only the first field;
receiving a first search query that includes the first field as a parameter as well as one or more other fields of the plurality of fields as parameters;
generating a reduced version of the first search query that does not include the one or more other fields;
running the reduced version of the first search query against the metadata portions of the first metadata structure to identify which metadata portions match the reduced version of the first search query; and
running the first search query against a subset of the portions in the structured data store, the subset including only portions of the structured data store that correspond to a metadata portion identified by running the reduced version of the first search query.

14. The computer storage media of claim 13, wherein generating a reduced version of the first search query that does not include the one or more other fields comprises removing any occurrences of the first field that are combined with another field using a logical OR.

15. The computer storage media of claim 13, wherein generating a reduced version of the first search query that does not include the one or more other fields comprises maintaining any occurrences of the first field that are combined with another field using a logical AND.

16. The computer storage media of claim 13, wherein the plurality of fields includes a second field, the method further comprising:
maintaining a second metadata structure that includes a metadata portion for each portion in the structured data store, each metadata portion in the second metadata structure identifying values of the second field that exist in the corresponding portion;
receiving a second search query that includes the second field as a parameter as well as one or more other fields of the plurality of fields as parameters;
generating a reduced version of the second search query that does not include the one or more other fields included in the second search query;
running the reduced version of the second search query against the metadata portions of the second metadata structure to identify which metadata portions match the reduced version of the second search query; and
running the second search query against a subset of the portions in the structured data store, the subset including only portions of the structured data store that correspond to a metadata portion identified by running the reduced version of the second search query.

17. The computer storage media of claim 16 wherein each metadata portion in the second metadata structure also identifies values of another field that exist in the corresponding portion; and
wherein the second search query includes the other field as a parameter such that generating a reduced version of the second search query comprises including the other field in the reduced version of the second search query.

18. A server system comprising:
an indexed store containing a plurality of segments that store documents having a plurality of fields including a first field;
a first metadata structure that includes a metadata segment for each segment in the indexed store, each metadata segment identifying values of the first field that exist in the corresponding segment; and
a query processor for running search queries against the indexed store;
wherein the query processor is configured to identify a subset of the segments of the indexed store against which the search queries should be run by performing the following:
in response to receiving a search query that includes the first field as a parameter as well as one or more other fields of the plurality of fields as parameters, generating a reduced version of the search query that does not include the one or more other fields; and
running the reduced version of the search query against the metadata segments of the first metadata structure to identify which metadata segments match the reduced version of the search query.

19. The server system of claim 18, wherein the plurality of fields include a second field, the server system further including:
a second metadata structure that includes a metadata segment for each segment in the indexed store, each metadata segment identifying values of the second field that exist in the corresponding segment.

20. The server system of claim 18, wherein the plurality of fields and the search query include one or more additional fields such that the reduced version of the search query also includes the one or more additional fields.
